(19) United States
(12) Patent Application Publication
(10) Pub. No.: US 2009/0178452 A1
(43) Pub. Date: Jul. 16, 2009

(54) DUST CONTROL OF SOLID GRANULAR MATERIALS

(75) Inventor: Mark Ogzewalla, Mulberry, FL (US)

Correspondence Address: DENNIS G. LAPOINTE;LAPOINTE LAW GROUP, PL, PO BOX 1294, TARPON SPRINGS, FL, 34688-1294, US

(73) Assignee: ARR-MAZ CUSTOM CHEMICALS, INC., Mulberry, FL (US)

(21) Appl. No.: 12/408,704

(22) Filed: Mar. 22, 2009

Related U.S. Application Data
(63) Continuation-in-part of application No. 11/838,910, filed on Aug. 15, 2007.
(60) Provisional application No. 60/839,871, filed on Aug. 24, 2006.

(51) Int. Cl. C09K 3/22; C05F 11/00

(52) U.S. Cl. 71/11; 252/88.1

(57) ABSTRACT

A method and composition for controlling dust and anti-caking of solid granular materials, including fertilizers, aggregates, minerals and ores wherein a glycerol which has been allowed to react with a polybasic acid to give a polymeric derivative for producing the composition which is applied to the solid granular materials.

### RELATED APPLICATION

This application is a continuation-in-part of U.S. patent application Ser. No. 11/838,910 filed Aug. 15, 2007, which in turns claims the benefit of U.S. Provisional Patent Application Ser. No. 60/839,871 filed Aug. 24, 2006.

### FIELD OF THE INVENTION

This invention relates to a dust control composition for solid granular materials such as fertilizers, aggregates, minerals and ores, for the purpose of reducing the initial dust levels present in such materials, reducing subsequent dust formation, and to reduce the tendency of the material particles to agglomerate or cake during storage and transportation.

### BACKGROUND OF THE INVENTION

Solid granular materials such as fertilizers, aggregates, minerals and ores are subject to dust formation during their manufacture, transportation, storage, and eventual use. Examples of solid granular materials that contain nuisance levels of dust include fertilizers such as ammonium phosphate, potash, granulated single super phosphate, triple super phosphate, ammonium sulfate, potassium nitrate, ammonium nitrate, and urea, and combinations of these to form so called NP or NPK fertilizers are subject to dust formation during their manufacture, transportation, storage, and eventual use at the farm or home. Other examples of solid granular materials that contain nuisance levels of dust include aggregates, often used in construction and other industrial applications: minerals and ores, which are used in many industrial applications, of which granulated borax is an example; and calcium phosphates, which are used as animal feed ingredients as well as in other applications. Dust from these solid granular materials can pose safety, health, environmental, housekeeping, and maintenance problems for producers, distributors and consumers.

The use of oils and waxes as coatings to control dust formation is well known. However, the use of these petroleum derived materials is often perceived as a possible environmental issue and more “green” or more easily biodegradable products for dust control and anti-caking coatings are sought.

### SUMMARY OF THE INVENTION

The present invention is the discovery of a method of controlling both initial and subsequent dust formation by coating the fertilizer particles with an environmentally friendly, bio-degradable material.

Glycerol, also known as glycerin, propane-1,2,3-triol, 1,2,3-propantriol, 1,2,3-trihydroxy propane, glyeritol and glycyl alchohol, has been used as a coating agent for solid granular materials but has limited effectiveness in view of its humectant properties and its poor dust binding or holding properties. It rapidly loses its ability to control dust over tire. Glycerol promotes caking because it absorbs moisture from the atmosphere. This absorbed moisture promotes crystal growth on granule surfaces and crystal bridging between individual granules which causes caking to occur. This crystal growth is also easily abraded from the granule surface increasing dust levels in the bulk material. Glycerol is a low viscosity liquid and as such has only minimal ability to adhere dust particles to the granule surface. Glycerol also absorbs easily into porous granules leaving the granule surface unprotected. As a result of these factors, glycerol has minimal effectiveness in controlling dust levels in granular solids.

It has been discovered that if glycerol is allowed to react with a polybasic acid such as citric acid to give a polymeric derivative, and the resultant product is used to coat the solid granular material, the initial excellent control of dust and reduction in caking tendencies is maintained for a prolonged time. In addition, the coating is both biodegradable and non-toxic.

### DETAILED DESCRIPTION OF THE INVENTION

As mentioned above, if glycerol is allowed to react with a polybasic acid such as citric acid to give a polymeric derivative, and the resultant product is used to coat solid granular materials such as fertilizers, aggregates, minerals and ores, the initial excellent control of dust and caking is maintained for a prolonged time. In addition, the coating is both biodegradable and non-toxic. The preparation of polymeric derivatives from glycerol and polybasic acids such as citric acid is well know to those skilled in the art. The reaction is self-catalyzing and proceeds at any temperature provided that the equilibrium is maintained by the removal of water generated during the reaction. Because removal of water is required, the reaction is usually carried out at elevated temperatures (above 100° C.) or under vacuum.

Examples of suitable glycerol include both natural glycerol derived from animal oils and fats or vegetable oils and fats and synthetic glycerol derived from petroleum feed stocks. Suitable grades of glycerin include, but are not limited to, crude glycerin from bio-diesel production, technical grade glycerin, USP Grade and FCC grade. The preferred polybasic acid is citric acid but may include other similar polybasic acids such as, but not limited to, succinic acid, adipic acid, maleic acid, fumeric acid and phosphoric acid.

In this invention the glycerol is polymerized with a polybasic acid in order to increase the viscosity and add body the resultant product. Glycerol is reacted with the polybasic acid in molar ratios ranging from 1.0 to 0.03 to 1.0 to 0.80. The reaction can be allowed to either proceed to completion or it can be stopped when the resultant product reaches the desired consistency by eliminating the water removal mechanism (ie. cooling, removing vacuum, etc.).

Tables 1-5 below provide examples of the improved dust control obtained by the present invention with various solid granular materials, including a mineral ore, granulated borax; animal feed ingredients, di-calcium phosphate, tri-calcium phosphate; and fertilizers, mono-ammonium phosphate and di-ammonium phosphate. Dust levels were determined using a dust tower similar to that described in the “Manual for Determining Physical Properties of Fertilizer” 2^{nd} edition, 1993, International Fertilizer Development Center, Muscle Shoals, Ala., at pages 69-72. In this test the granular solid particles are through a counter current air stream and are agitated at the same time by passing through a series of grates. The dust particles are collected on a filter and the dust levels determined by measuring the changes in weight on an analytical balance. Dust levels were determined both initially after treatment with the de-dusting agents and again after aging for 14 days in a 140° F. (60° C.) oven. After removal from the oven the samples are allowed to cool for 24 hours. This aging process is designed to simulate the increase in dust levels normally encountered during the storage of granular solid materials.

Table 1 demonstrates the effectiveness of glycerol reacted with citric acid, in a 1.0 to 0.05 molar ratio, in controlling dust on granular borax. The glycerol and citric acid were mixed together and heated to 115° C. for 4 hours in a reaction flask. Water that was generated by the reaction was removed by sweeping the surface of the liquid with air. The water vapor was collected using a condenser and trap. Initial dust levels were determined after the borax was treated with the reaction product, mineral oil, vegetable oil and two commercial de-dusting agents at two application rates, 1.0 and 2.0 gallons per ton. All coatings were applied by heating them to between 60° C. and 70° C. and spraying the coating onto a rolling bed of granular material contained in a rotating drum.

Tables 2 and 3 demonstrate the effectiveness of glycerol reacted with citric acid, in a 1.0 to 0.05 molar ratio and 1.0 to 0.10 molar ratio, in controlling dust on granular di-calcium phosphate and granular tri-calcium phosphate. The glycerol and citric acid were mixed together and heated to 115° C. for 4 hours in a reaction flask. Water that was generated by the reaction was removed by sweeping the surface of the liquid with air. The water vapor was collected using a condenser and trap. Both initial dust levels and aged dust levels were determined after the calcium phosphates were treated with the reaction products and three commercial de-dusting agents suitable for use on animal feed ingredients at two application rates, 1.0 and 2.0 gallons per ton. All coatings were applied by heating them to between 60° C. and 70° C. and spraying the coating onto a rolling bed of granular material contained in a rotating drum.

Tables 4 and 5 demonstrate the effectiveness of glycerin reacted with citric acid, in a 1.0 to 0.10 molar ratio and 1.0 to 0.40 molar ratio, in controlling dust on granular mono-ammonium phosphate and granular di-ammonium phosphate. The glycerol and citric acid were mixed together and heated to 115° C. for 4 hours in a reaction flask. Water that was generated by the reaction was removed by sweeping the surface of the liquid with air. The water vapor was collected using a condenser and trap. Both initial dust levels and aged dust levels were determined after the ammonium phosphates were treated with the reaction products, mineral oil and two different commercial de-dusting agents, at application rates of 0.5 gallons per ton. All coatings were applied by heating them to between 60° C. and 70° C. and spraying the coating onto a rolling bed of granular material contained in a rotating drum.

DUSTROL® or KGA™ de-dusting agents are commercial dust control agents, all manufactured and sold by ARR-MAZ Custom Chemicals, Inc., of Mulberry, Fla., US.

Accordingly, the invention is a dust control composition for solid granular materials such as fertilizers, aggregates, minerals and ores comprising a composition for coating said granular-solids in which glycerol is allowed to react with a polybasic acid to give a polymeric derivative for producing said composition. A preferred polybasic acid is citric acid.

The preferred ratio of the glycerol to polybasic acid can be from 1.0 to 0.03 to 1.0 to 0.80, depending on the viscosity requirements for application to the fertilizer, and the desired application amount can range from 0.5 to 40 pounds per ton of fertilizer material.

The invention also includes a method for controlling dust and anti-caking of solid granular materials comprising applying to the material a coating composition comprising glycerol which has been allowed to react with a polybasic acid to give a polymeric derivative for producing said composition, as described above.

It should be understood that the preceding is merely a detailed description of one or more embodiments of this invention and that numerous changes to the disclosed embodiments, can be made in accordance with the disclosure herein without departing from the spirit and scope of the invention. The preceding description, therefore, is not meant to limit the scope of the invention. Rather, the scope of the invention is to be determined only by the appended claims and their equivalents.

TABLE 1
Dust Tests with Granulated Borax

| | | Application | Application | | |
|---|---|---|---|---|---|
| | | Rate | Rate | Dust Levels | Reduction in |
| | Specific | (Gallons per | (Pounds per | (Part per | Dust Levels |
| De-Dusting Agent | Gravity | Ton) | Ton) | Million) | (%) |
| None | NA | 0.0 | 0.0 | 15,850 | 0.0 |
| Mineral Oil | 0.914 | 1.0 | 7.6 | 9,150 | 42.3 |
| DUSTROL 3082 | 0.924 | 1.0 | 7.7 | 2,350 | 85.2 |
| Vegetable Oil | 0.890 | 1.0 | 7.3 | 3,900 | 75.4 |
| DUSTROL 3876 | 1.260 | 1.0 | 10.6 | 1,400 | 91.2 |
| Glycerin Citric Acid | 1.340 | 1.0 | 11.2 | 1,100 | 93.1 |
| (1 to 0.1) | | | | | |
| None | NA | 0.0 | 0.0 | 15,850 | 0.0 |
| Mineral Oil | 0.914 | 2.0 | 15.2 | 8,365 | 47.2 |
| DUSTROL 3082 | 0.924 | 2.0 | 15.4 | 1,754 | 88.9 |
| Vegetable Oil | 0.890 | 2.0 | 14.9 | 3,580 | 77.4 |
| DUSTROL 3876 | 1.260 | 2.0 | 21.1 | 1,175 | 92.6 |
| Glycerin Citric Acid | 1.340 | 2.0 | 22.3 | 865 | 94.5 |
| (1 to 0.1) | | | | | |

TABLE 2
Dust Tests with Di-Calcium Phosphate

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 2,850 | 0.0 | 5,400 | 0.0 |
| KGA 200 | 1.209 | 1.0 | 10.1 | 2,350 | 17.5 | 4,700 | 13.0 |
| KGA 700 | 1.243 | 1.0 | 10.4 | 1,650 | 42.1 | 2,900 | 46.3 |
| KGA 517 | 1.200 | 1.0 | 10.0 | 2,300 | 19.3 | 5,200 | 3.7 |
| Glycerin Citric Acid | 1.340 | 1.0 | 11.2 | 2,450 | 14.0 | 4,650 | 13.9 |
| (1 to 0.1) | | | | | | | |
| Glycerin Citric Acid | 1.348 | 1.0 | 11.3 | 1,000 | 64.9 | 1,850 | 65.7 |
| (1 to 0.2) | | | | | | | |
| None | NA | 0.0 | 0.0 | 2,850 | 0.0 | 5,400 | 0.0 |
| KGA 200 | 1.209 | 2.0 | 20.2 | 2,300 | 57.4 | 4,750 | 12.0 |
| KGA 700 | 1.243 | 2.0 | 20.7 | 1,100 | 79.6 | 2,250 | 58.3 |
| KGA 517 | 1.200 | 2.0 | 20.0 | 2,250 | 58.3 | 4,800 | 11.1 |
| Glycerin Citric Acid | 1.340 | 2.0 | 22.4 | 2,050 | 62.0 | 3,850 | 28.7 |
| (1 to 0.1) | | | | | | | |
| Glycerin Citric Acid | 1.348 | 2.0 | 22.6 | 650 | 88.0 | 1,400 | 74.1 |
| (1 to 0.2) | | | | | | | |

TABLE 3
Dust Tests with Tri-Calcium Phosphate

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 8,400 | 0.0 | 16,300 | 0.0 |
| KGA 200 | 1.209 | 1.0 | 10.1 | 1,950 | 76.8 | 3,150 | 80.7 |
| KGA 700 | 1.243 | 1.0 | 10.4 | 2,200 | 73.8 | 3,600 | 77.9 |
| KGA 517 | 1.200 | 1.0 | 10.0 | 5,250 | 37.5 | 9,200 | 43.6 |
| Glycerin Citric Acid | 1.340 | 1.0 | 11.2 | 1,500 | 82.1 | 2,050 | 87.4 |
| (1 to 0.1) | | | | | | | |
| Glycerin Citric Acid | 1.348 | 1.0 | 11.3 | 1,100 | 86.9 | 1,700 | 89.6 |
| (1 to 0.2) | | | | | | | |
| None | NA | 0.0 | 0.0 | 8,400 | 0.0 | 16,300 | 0.0 |
| KGA 200 | 1.209 | 2.0 | 20.2 | 1,000 | 93.9 | 2,500 | 84.7 |
| KGA 700 | 1.243 | 2.0 | 20.7 | 1,150 | 92.9 | 2,400 | 85.3 |
| KGA 517 | 1.200 | 2.0 | 20.0 | 1,400 | 91.4 | 3,700 | 77.3 |
| Glycerin Citric Acid | 1.340 | 2.0 | 22.4 | 1,000 | 93.9 | 2,150 | 86.8 |
| (1 to 0.1) | | | | | | | |
| Glycerin Citric Acid | 1.348 | 2.0 | 22.6 | 600 | 96.3 | 1,000 | 93.9 |
| (1 to 0.2) | | | | | | | |

TABLE 4
Dust Tests with Mono-Ammonium Phosphate

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 1,236 | 0.0 | 1,966 | 0.0 |
| Mineral Oil | 0.091 | 0.5 | 7.6 | 520 | 57.9 | 830 | 57.8 |
| DUSTROL 3088 | 0.924 | 0.5 | 7.7 | 310 | 74.9 | 685 | 65.2 |
| DUSTROL 3017 | 0.959 | 0.5 | 8.0 | 165 | 86.7 | 290 | 85.2 |
| Glycerin Citric Acid | 1.348 | 0.5 | 11.2 | 75 | 93.9 | 335 | 83.0 |
| (1 to 0.2) | | | | | | | |
| Glycerin Citric Acid | 1357 | 0.5 | 11.3 | 50 | 96.0 | 315 | 84.0 |
| (1 to 0.8) | | | | | | | |

TABLE 5
Dust Tests with Di-Ammonium Phosphate

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 1,030 | 0.0 | 1,710 | 0.0 |
| Mineral Oil | 0.091 | 0.5 | 7.6 | 240 | 76.7 | 765 | 55.3 |
| DUSTROL 3088 | 0.924 | 0.5 | 7.7 | 180 | 82.5 | 550 | 67.8 |
| DUSTROL 3017 | 0.959 | 0.5 | 8.0 | 30 | 97.1 | 190 | 88.9 |
| Glycerin Citric Acid | 1.348 | 0.5 | 11.2 | 20 | 98.1 | 210 | 87.7 |
| (1 to 0.2) | | | | | | | |
| Glycerin Citric Acid | 1.357 | 0.5 | 11.3 | 5 | 99.5 | 320 | 81.3 |
| (1 to 0.8) | | | | | | | |

What is claimed is:

1. A dust control composition for solid granular materials, including fertilizers, aggregates, minerals and ores, comprising:
a composition for coating solid granular materials in which glycerol is allowed to react with a polybasic acid to give a polymeric derivative for producing said composition.

2. The composition according to claim 1, wherein the polybasic acid is citric acid.

3. The composition according to claim 1, wherein a molar ratio of the polybasic acid to glycerin is from about 0.03 to 1 to about 0.8 to 1.

4. The composition according to claim 3, wherein a desired application amount ranges from about 0.5 to 40 pounds per ton of solid granular materials.

5. A method for controlling dust and anti-caking of solid granular materials, including fertilizers, aggregates, minerals and ores, comprising:
applying to said solid granular materials a coating composition comprising glycerol which has been allowed to react with a polybasic acid to give a polymeric derivative for producing said composition.

6. The method according to claim 5, wherein the polybasic acid is citric acid.

7. The method according to claim 5, wherein a ratio of the polybasic acid to glycerol is from about 0.03 to 1 to about 0.8 to 1.

8. The method according to claim 7, wherein a desired application amount ranges from about 0.5 to 40 pounds per ton of solid granular materials.
